(19) United States
(12) Patent Application Publication
(10) Pub. No.: US 2026/0279895 A1
(43) Pub. Date: Sep. 17, 2026

(54) COMPOSITE SOLID ELECTROLYTE, THERMAL BATTERY COMPRISING SAME, AND MANUFACTURING METHOD THEREFOR

(71) Applicant: AGENCY FOR DEFENSE DEVELOPMENT, Daejeon (KR)

(72) Inventors: Minu KIM, Daejeon (KR); Hae Won CHEONG, Daejeon (KR); Tae Young AHN, Daejeon (KR); Chaehyeok HAN, Daejeon (KR); Hee Sook ROH, Daejeon (KR); Seoung Ho KANG, Daejeon (KR); Yu Song CHOI, Daejeon (KR); Jang Hyeon CHO, Daejeon (KR)

(21) Appl. No.: 19/168,011

(22) PCT Filed: Mar. 20, 2024
(86) PCT No.: PCT/KR2024/003476

§ 371 Date: Nov. 11, 2025

(30) Foreign Application Priority Data
Mar. 24, 2023 (KR) 10-2023-0039288
May 19, 2023 (KR) 10-2023-0065230

(51) Int. Cl. H01M 10/0562; H01M 10/615

(52) U.S. Cl. CPC H01M 10/0562; H01M 10/615; H01M 2300/008; H01M 2300/0085

(57) ABSTRACT

The present invention relates to a composite solid electrolyte, a thermal battery comprising same, and a manufacturing method therefor. An embodiment of the present invention provides a manufacturing method for a composite solid electrolyte, the method comprising the steps of: mixing a precursor mixture and a molten salt to form a molten salt-precursor mixture; calcining the molten salt-precursor mixture to form a molten salt-coated solid electrolyte mixture; and pulverizing the molten salt-coated solid electrolyte mixture to obtain a composite solid electrolyte powder.

### TECHNICAL FIELD

The present disclosure relates to a composite solid electrolyte, a thermal battery including the same, and a method for manufacturing the same.

### BACKGROUND ART

A thermal battery is a reserve battery which is activated when an electrically insulating solid phase molten salt is melted at a high temperature and undergoes a phase transition into an ion conductive liquid phase electrolyte. A eutectic salt, such as LiF—LiCl—LiBr and LiCl—KCl, which is most widely used as an electrolyte in the thermal battery, has high ion conductivity, but has a high melting point of 300° C. to 450° C. Though the eutectic salt has insulating properties in a solid state, it may have conductivity when melted to be in a liquid state. The thermal battery may be stored in an inactive state at room temperature and then activated at about 500° C. at which a solid phase eutectic salt is melted and undergoes a phase transition into a liquid phase electrolyte. The activated thermal battery is slowly cooled and may stop working due to a phase transition of the liquid phase electrolyte into a solid phase again.

The eutectic salt may be provided in a state of being impregnated in a binder including sand, porous media, metal forms, and the like (U.S. Patent Publication No. 2016-0072153, Japanese Patent Registration No. 6592030, Korean Patent Registration No. 10-1750203, U.S. Patent Registration No. 10,998,583, and Korean Patent Registration No. 10-2143173).

### DETAILED DESCRIPTION OF THE INVENTION

### Technical Goals

A traditional thermal battery causes electrolytic solution leakage, increased internal resistance, or short circuit, when a molten salt is melted to be a liquid phase electrolyte. The present disclosure is for solving various problems including the above, and the present disclosure is intended to provide a composite solid electrolyte having high ion conductivity, a thermal battery including the same, and a method for manufacturing the same. However, the problems are illustrative, and the scope of the present disclosure is not limited thereby.

### Technical Solutions

According to an aspect of the present disclosure, provided is a method for manufacturing a composite solid electrolyte including: mixing a precursor mixture and a molten salt to form a molten salt-precursor mixture; calcining the molten salt-precursor mixture to form a solid electrolyte mixture coated with the molten salt; and pulverizing the solid electrolyte mixture coated with the molten salt to obtain a composite solid electrolyte powder.

In an example embodiment, the molten salt may be LiF—LiCl—LiBr, LiCl—KCl, LiF—LiBr—KBr, LiBr—KBr—RbCl, or a mixture thereof.

In an example embodiment, the precursor mixture may include a raw material composition including a lithium element, a lanthanum element, and a zirconium element.

In an example embodiment, the precursor mixture may further include an additive, and the additive may include one or more of tantalum oxide and strontium carbonate.

In an example embodiment, the precursor mixture may include a raw material composition including a lithium element, a phosphorus element, and a sulfur element.

In an example embodiment, a weight ratio of the molten salt to the molten salt-precursor mixture may be 10 wt % to 80 wt %, and a weight ratio of the precursor mixture to the molten salt-precursor mixture may be 20 wt % to 90 wt %.

In an example embodiment, the weight ratio of the molten salt to the molten salt-precursor mixture may be 30 wt % to 80 wt %, and the weight ratio of the precursor mixture to the molten salt-precursor mixture may be 20 wt % to 70 wt %.

In an example embodiment, a calcinating temperature of the molten salt-precursor mixture may be 550° C. to 1,150° C.

In an example embodiment, forming of the solid electrolyte mixture coated with the molten salt may include: calcining the molten salt-precursor mixture to form a mixed solution of a liquid phase molten salt and a solid phase electrolyte, and solidifying the mixed solution to separate an upper salt including the molten salt and a lower salt including the solid electrolyte mixture coated with the molten salt.

According to another aspect of the present disclosure, a composite solid electrolyte manufactured by any one of the methods for manufacturing a composite solid electrolyte described above is provided.

According to still another aspect of the present disclosure, provided is a thermal battery including: a negative electrode current collector, a negative electrode layer placed on an upper portion of the negative electrode current collector, a composite solid electrolyte layer placed on an upper portion of the negative electrode layer, a positive electrode layer placed on an upper portion of the solid electrolyte layer, and a heat source placed on an upper portion of the positive electrode layer, in which the composite solid electrolyte layer is formed by mixing a precursor mixture and a molten salt to form a molten salt-precursor mixture, calcining the molten salt-precursor mixture to form a solid electrolyte mixture coated with the molten salt, pulverizing the solid electrolyte mixture coated with the molten salt to obtain a composite solid electrolyte powder, and pelletizing the powder.

Other aspects, features, and advantages than those mentioned above will become obvious from the following drawings, claims, and detailed description of the present disclosure.

### Effects of the Invention

According to an example embodiment of the present disclosure as described above, a composite solid electrolyte which is coated with a molten salt and has high ion conductivity and a thermal battery including the electrolyte may be implemented. In addition, a method for manufacturing the composite solid electrolyte according to an example embodiment of the present disclosure may simplify the process and obtain a high-quality composite solid electrolyte at low cost, by omitting a washing process in synthesis operation of a solid electrolyte. Of course, the scope of the present disclosure is not limited by the effects.

### BRIEF DESCRIPTION OF DRAWINGS

FIG. 1 is a drawing schematically showing a unit cell of a thermal battery including the composite solid electrolyte according to an example embodiment of the present disclosure.

FIG. 2 is a block diagram schematically showing a method for manufacturing the composite solid electrolyte according to an example embodiment of the present disclosure.

FIG. 3 is a drawing schematically showing a molten salt-precursor mixture, and

FIG. 4 is a drawing schematically showing a solid electrolyte mixture coated with a molten salt.

FIG. 5 is a drawing for describing a composite solid electrolyte layer obtained by uniaxial pressure molding of the solid electrolyte mixture coated with a molten salt obtained in FIG. 4.

FIG. 6 is a drawing for describing a precipitation separation method of the solid electrolyte mixture coated with the molten salt.

FIG. 7a is a graph showing the results of X-ray diffraction analysis of a composite solid electrolyte manufactured using a LiBr—LiCl—LiF eutectic salt, and FIG. 7b is a graph showing the results of X-ray diffraction analysis of the composite solid electrolyte manufactured using a LiCl—KCl eutectic salt.

### BEST MODE FOR CARRYING OUT THE INVENTION

Since the present disclosure may be variously modified and have several example embodiments, specific example embodiments will be shown in the accompanying drawings and be described in detail in the detailed description. The effects and features of the present disclosure and the method of achieving them will be elucidated from example embodiments described in detail below with reference to the drawings. However, the present disclosure is not limited to the example embodiments disclosed later, but may be implemented in various forms.

Hereinafter, the example embodiments of the present disclosure will be described in detail with respect to the attached drawings, and in the description with reference to the drawings, identical or corresponding constituent elements are designated by the same reference numerals, and overlapping description is omitted.

In the present specification, the terms such as “first” and “second” are not used in a limited meaning, but used for the purpose of distinguishing one constituent element from other constituent elements.

Singular forms in the present specification are intended to include plural forms unless the context clearly indicates otherwise.

In the present specification, the terms such as “comprise” or “have” mean that there are features or constitutional elements described in the specification, and a possibility of adding one or more other features or constitutional elements is not excluded in advance.

In the present specification, the terms such as “about” or “approximately” include a stated value, and the stated value may be within an acceptable range of deviation determined by considering errors related to manufacturing methods or measuring methods. For example, the term “about” in the present specification may refer to within ±20%, ±10%, or ±5% of the stated value.

In the present specification, when some example embodiments may be implemented otherwise, specific process sequences may be performed in a different order than described. For example, two process described in succession may be performed substantially simultaneously, or in the opposite order of the described order.

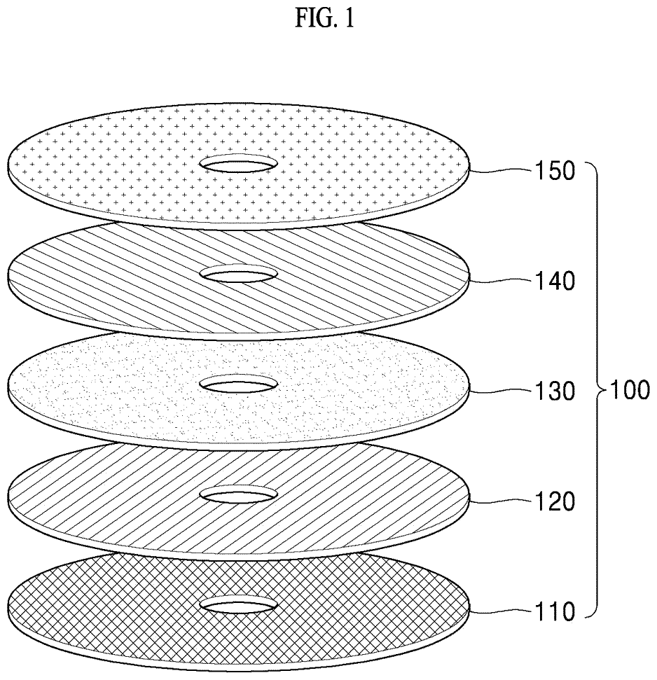

FIG. 1 is a drawing schematically showing a unit cell of a thermal battery including the composite solid electrolyte according to an example embodiment of the present disclosure.

Referring to FIG. 1, a unit cell 100 of a thermal battery including the composite solid electrolyte according to an example embodiment of the present disclosure may include a negative electrode current collector 110, a negative electrode 120, a composite solid electrolyte layer 130, a positive electrode 140, and a heat source 150.
Each of the negative electrode current collector 110, the negative electrode 120, the composite solid electrolyte layer 130, the positive electrode 140, and the heat source 150 may be provided in a pellet form and stacked sequentially.

The negative electrode current collector 110 may include a metal material. For example, the negative electrode current collector 110 may include stainless steel or nickel (Ni).

The negative electrode 120 may be placed on the negative electrode current collector 110. The negative electrode 120 may include a lithium-silicon alloy or pure lithium. In an example embodiment, the negative electrode 120 may be manufactured in a pellet shape by mixing pure lithium with iron powder. In another example embodiment, the negative electrode 120 may be manufactured by impregnating pure lithium with a metal foam having a plurality of pores.

The composite solid electrolyte layer 130 may be placed on the negative electrode 120. The composite solid electrolyte layer 130 may be formed by mixing a precursor mixture and a molten salt to form a molten salt-precursor mixture, calcining the formed molten salt-precursor mixture in a temperature range of about 550° C. to about 1,150° C. to form a solid electrolyte mixture coated with the molten salt, pulverizing the solid electrolyte mixture coated with the molten salt to obtain a composite solid electrolyte powder, and pelletizing the powder.

In an example embodiment, the precursor mixture may include a raw material composition including a lithium element, a lanthanum element, and a zirconium element. In another example embodiment, the precursor mixture may include a raw material composition including a lithium element, a phosphorus element, and a sulfur element.

The molten salt may be LiF—LiCl—LiBr, LiCl—KCl, LiF—LiBr—KBr, or LiBr—KBr—RbCl, which is a eutectic salt, or a mixture thereof.

The positive electrode 140 may be placed on the composite solid electrolyte layer 130. The positive electrode 140 may include iron sulfide (FeS₂), cobalt sulfide (CoS₂), nickel sulfide (NiS₂), iron fluoride (FeF₃), or a combination thereof.

The heat source 150 may be placed on the positive electrode 140. In this regard, FIG. 1 shows that the heat source 150 is disposed on the positive electrode 140, but the arrangement and the like of the heat source 150 may be changed for effectively activating the thermal battery.

The thermal battery may include one or more unit cells 100. For example, one thermal battery may have a structure in which a plurality of unit cells 100 are stacked and connected in series.

### MODE FOR CARRYING OUT THE INVENTION

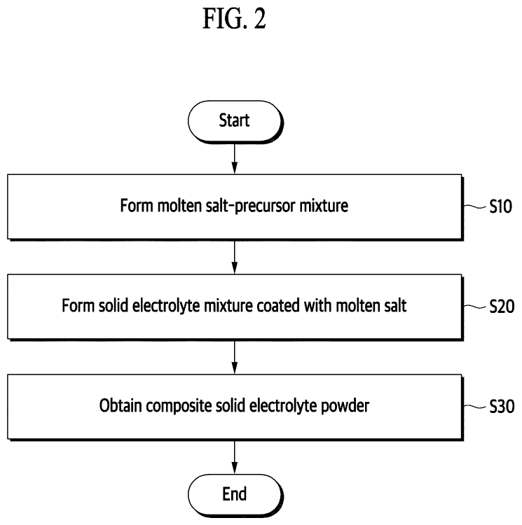

FIG. 2 is a block diagram schematically showing a method for manufacturing the composite solid electrolyte according to an example embodiment of the present disclosure.

Referring to FIG. 2, the method for manufacturing a composite solid electrolyte according to an example embodiment of the present disclosure may include: (S10) forming a molten salt-precursor mixture, (S20) forming a solid electrolyte mixture coated with the molten salt, and (S30) obtaining a composite solid electrolyte powder.

The forming of a molten salt-precursor mixture (S10) may be operation of mixing a precursor mixture and a molten salt.

When the precursor mixture is calcined with the molten salt, it may be a raw material composition which may synthesize an oxide-based solid electrolyte including lithium or a sulfide-based solid electrolyte including lithium.

In an example embodiment, the precursor mixture may include a raw material composition for synthesizing an oxide-based solid electrolyte including lithium. For example, the precursor mixture may include a raw material composition including a lithium element, a lanthanum element, and a zirconium element. The oxide-based solid electrolyte including lithium may be Li_{6.5}La₃Zr₂₋ₓTaₓO₁₂ (x=0.3-0.7) (hereinafter, referred to as LLZO). The LLZO solid electrolyte has excellent stability at a high temperature.

In another example embodiment, the precursor mixture may include a raw material composition for synthesizing a sulfide-based solid electrolyte including lithium. For example, the precursor mixture may include a raw material composition including a lithium element, a phosphorus element, and a sulfur element. The sulfide-based solid electrolyte including lithium may be argyrodite.

The precursor mixture may further include an additive for doping the solid electrolyte. For example, the additive may include one or more of tantalum oxide (Ta₂O₅) and strontium carbonate (SrCO₃).

The molten salt may include a eutectic salt which is dissolved at a specific temperature or higher. The molten salt does not react with the negative electrode and the positive electrode of the thermal battery and may be a material which is melted at a temperature lower than the decomposition temperature of a positive electrode material and a positive electrode material. In an example embodiment, the molten salt may be LiF—LiCl—LiBr, LiCl—KCl, LiF—LiBr—KBr, LiBr—KBr—RbCl, or a mixture thereof.

The precursor mixture may be prepared in a solid phase powder form. In an example embodiment, the molten salt is prepared in a solid phase powder form and may be uniformly mixed by a ball-milling process with the precursor mixture. In another example embodiment, the molten salt may be heat treated in a temperature range of about 450° C. to about 650° C. and mixed with the precursor mixture in at least a partially molten state.

In an example embodiment, the molten salt may have a weight ratio of about 10 wt % to about 50 wt % with respect to the molten salt-precursor mixture, and the precursor mixture may have a weight ratio of about 50 wt % to 90 wt % with respect to the molten salt-precursor mixture. In this case, a process of separating and removing a residual molten salt after the calcination process may be omitted.

In another example embodiment, the molten salt-precursor mixture may include an excessive amount of molten salt. The molten salt may have the weight ratio of about 30 wt % to about 80 wt % with respect to the molten salt-precursor mixture, and the precursor mixture may have the weight ratio of about 20 wt % to 70 wt % with respect to the molten salt-precursor mixture.

In another example embodiment, the molten salt may have the weight ratio of about 10 wt % to about 80 wt % with respect to the molten salt-precursor mixture, and the precursor mixture may have the weight ratio of about 20 wt % to 90 wt % with respect to the molten salt-precursor mixture.

The forming of a solid electrolyte mixture coated with the molten salt (S20) may be operation of calcining the molten salt-precursor mixture to form a solid electrolyte mixture coated with the molten salt.

The molten salt-precursor mixture may be calcined in a temperature range of about 550° C. to about 1,150° C. to grow a solid electrolyte crystal. In an example embodiment, the calcining of the molten salt-precursor mixture may be performed in a low temperature range of about 800° C. to about 1,000° C.

When the solid electrolyte is synthesized by a traditional solid phase synthesis method, a heat treatment process at a high temperature of 1,100° C. or higher is needed, and thus, the solid electrolyte is out of the stoichiometric composition or a secondary phase is formed due to volatilization of lithium and the like. However, since the method for manufacturing a composite solid electrolyte according to the example embodiments of the present disclosure grows a solid electrolyte crystal with only one heat treatment at a relatively low temperature, a high-quality solid electrolyte may be synthesized at low cost.

An additive for doping the solid electrolyte may increase lithium vacancies and lithium ion conducting channels of the solid electrolyte through chemical substitution of elements, when growing the solid electrolyte crystal. For example, when the solid electrolyte is LLZO, the strontium element of the additive may be substituted with a lanthanum element, and the tantalum element of the additive may be substituted with a zirconium element.

In an example embodiment, when the molten salt-precursor mixture is calcined, an excessive amount of molten salt may be further added. For example, the molten salt having the weight ratio of about 30 wt % to 100 wt % may be further added with respect to the molten salt-precursor mixture. A synthesis rate of the solid electrolyte may be improved by further adding the molten salt to compensate for a lithium element which volatilizes during a heat treatment process.

The calcination of the molten salt-precursor mixture may be performed within a time range of about 2 hours to about 10 hours. When the calcination process time is less than 2 hours, each crystal grain may not grow well. When the calcination process time is more than 10 hours, properties such as ion conductivity may be deteriorated due to coarsening of crystal grains.

In an example embodiment, the forming of a solid electrolyte mixture coated with the molten salt (S20) may include: calcining the molten salt-precursor mixture to form a mixed solution of a liquid phase molten salt and a solid phase electrolyte, and solidifying the mixed solution to separate an upper salt including the molten salt and a lower salt including the solid electrolyte mixture coated with the molten salt.

When the solid electrolyte is LLZO, the density of the solid electrolyte (5.26 g/cm³) may be higher than the density of LiCl—KCl (2.02 g/cm³) and the density of LiF—LiCl—LiBr (2.92 g/cm³). Therefore, when the mixed solution is slowly cooled, the solid electrolyte having a high density is precipitated, and only a residual molten salt remaining after use in synthesis may be positioned in the upper portion of the mixed solution. Therefore, a solid electrolyte mixture coated with the molten salt may be obtained by removing a solidified upper salt. Herein, the position of a cutting line which separates the upper salt and the lower salt may be adjusted depending on the amount of the molten salt included in the final composite solid electrolyte powder.

The obtaining of a composite solid electrolyte powder (S30) may be operation of pulverizing the solid electrolyte mixture coated with the molten salt to obtain a composite solid electrolyte powder.

The finally obtained composite solid electrolyte powder may have a core-shell structure in which the surface of the solid electrolyte particle is coated with the molten salt.

Though not shown in FIG. 2, the method for manufacturing a composite solid electrolyte according to an example embodiment of the present disclosure may further include pelletizing the composite solid electrolyte powder.

In operation of pelletizing the composite solid electrolyte powder, the composite solid electrolyte powder is filled into a mold, and heat treated and pressurized at about 150° C. to about 300° C. to manufacture a pelletized composite solid electrolyte layer 130 (see FIG. 1). The molten salts coated on the surface of the solid electrolyte particle may be bonded to each other in operation of pelletizing to form a structure having high density and high strength.

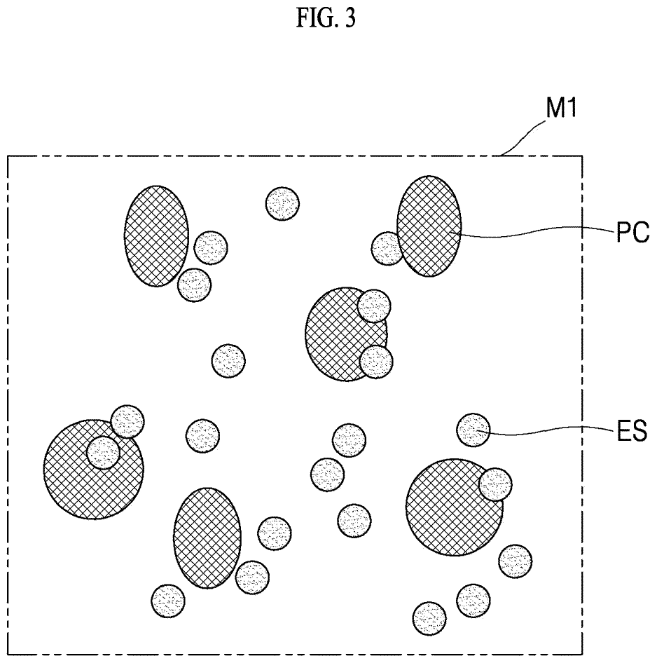

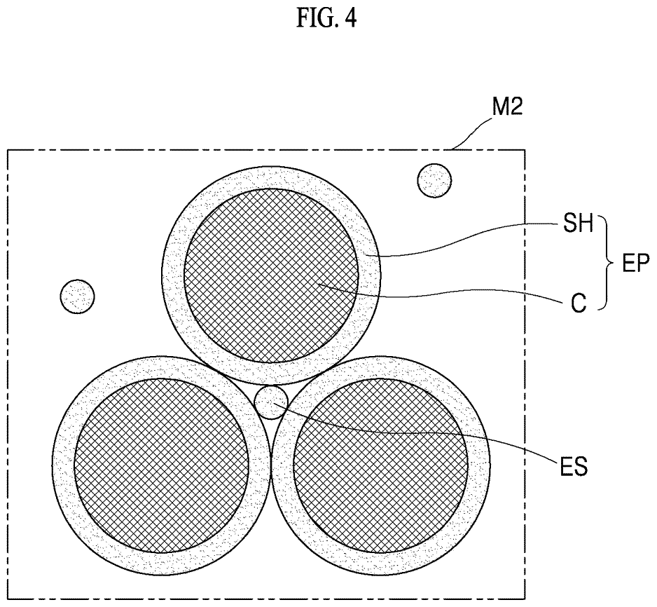

FIG. 3 is a drawing schematically showing a molten salt-precursor mixture, and FIG. 4 is a drawing schematically showing a solid electrolyte mixture coated with the molten salt. FIG. 3 schematically shows a molten salt-precursor mixture (M1) formed in the forming of a molten salt-precursor mixture (S10, see FIG. 2), and FIG. 4 schematically shows a solid electrolyte mixture (M2) coated with the molten salt formed in the forming of a solid electrolyte mixture (S20, see FIG. 2).

Referring to FIG. 3, the molten salt-precursor mixture (M1) may include solid phase precursor mixtures (PC) and molten salts (ES).

The precursor mixtures (PC) may be a raw material composition including a lithium element, a lanthanum element, and a zirconium element. For example, the precursor mixture (PC) may include lithium carbonate (Li₂CO₃), lanthanum oxide (La₂O₃), and zirconium oxide (ZrO₂). In an example embodiment, lithium carbonate having high volatility properties may be added in excess, so that the composition of the finally formed solid electrolyte crystal is not out of the desired composition.

Alternatively, the precursor mixtures (PC) may be a raw material composition including a lithium element, a phosphorus element, and a sulfur element. In an example embodiment, argyrodite (Li₆PS₅Cl) may be synthesized by a molten salt synthesis method. Herein, the precursor mixtures (PC) with the molten salt may further include an additive. In this case, the additive may include one or more of lithium sulfide (Li₂S), phosphorus sulfide (P₂S₅), and lithium chloride (LiCl).

The molten salts(ES) may be prepared in a solid phase powder form and mixed with the precursor mixture (PC). Alternatively, the molten salts (EC) may be heat treated in a temperature range of about 450° C. to about 650° C. and mixed with the precursor mixture in at least a partially molten state.

Referring to FIG. 4, the solid electrolyte mixture (M2) coated with the molten salt may include molten salts(ES) and a solid electrolyte powder (EP) coated with the molten salt. The solid electrolyte powder (EP) coated with the molten salt may have a core-shell structure in which a core (C) which is a solid electrolyte particle is coated with the molten salt to form a molten salt shell (SH).

The core (C) may include a solid electrolyte particle having uniform crystallinity. As described above, the solid electrolyte particle may be an oxide-based solid electrolyte including lithium or a sulfide-based solid electrolyte including lithium. For example, the core (C) may include Li₇₋ₓLa₃Zr₂₋ₓTaₓO₁₂ (x=0.3-0.7) or argyrodite (Li₆PS₅Cl) crystal.

The solid electrolyte particle may prevent or reduce leakage of a molten liquid, even in the case in which a thermal battery is operated to melt the molten salt.

A traditional solid electrolyte synthesis method needed a first heat treatment performed at about 900° C. and a second heat treatment performed at about 1130° C. However, the example embodiments of the present disclosure may synthesize a solid electrolyte particle having excellent crystallinity with only one heat treatment at a low temperature of about 550° C. to about 1,150° C. by using the molten salt.

A molten salt shell (SH) is an insulating layer for preventing self-discharge of the solid electrolyte particle at room temperature and may increase the shelf life of the thermal battery to 10 years or more. In addition, since the molten salt shell (SH) is melted at a temperature at which the thermal battery is operated and has high ion conductivity, the output characteristics of the thermal battery may be improved.

The solid electrolyte mixture (M2) coated with the molten salt may further include uncoated molten salt (ES) particles in the solid electrolyte particles.

In an example embodiment, the solid electrolyte mixture (M2) coated with the molten salt may be used as the electrolyte of the thermal battery without a subsequent processing process such as sintering. Therefore, the manufacturing cost of the thermal battery may be lowered.

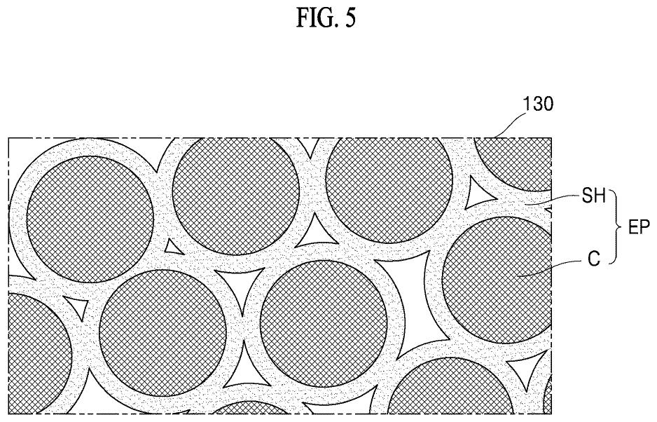

FIG. 5 is a drawing for describing a composite solid electrolyte layer obtained by uniaxial pressure molding of the solid electrolyte mixture coated with a molten salt obtained in FIG. 4.

As described above, the solid electrolyte mixture (M2) coated with the molten salt may have a core-shell structure in which the core (C) which is a solid electrolyte particle is coated with the molten salt to form a molten salt shell (SH).

Referring to FIG. 5, when the solid electrolyte mixture (M2) coated with the molten salt is pressure-molded in a uniaxial press, the composite solid electrolyte 130 having increased density may be manufactured as in FIG. 5. The molten salt forming the composite solid electrolyte layer 130 and the molten salt shell (SH) of each solid electrolyte powder (EP) coated with the molten salt may be bonded to each other to form a structure having high density and high strength.

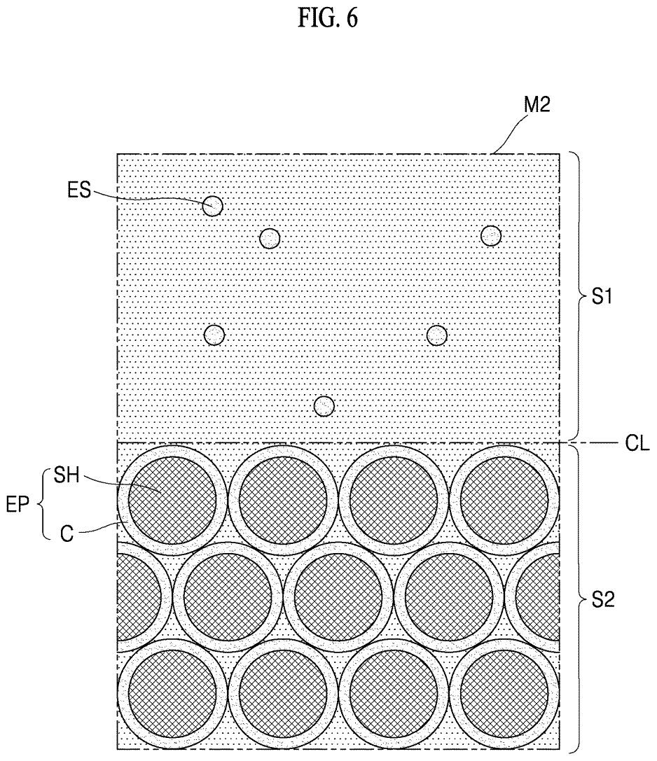

FIG. 6 is a drawing for describing a precipitation separation method of the solid electrolyte mixture coated with the molten salt.

Referring to FIG. 6, the solid electrolyte mixture (M2) coated with the molten salt may further include molten salt (ES) and a solid electrolyte powder (EP) coated with the molten salt.

In general, since the density of the solid electrolyte particle is higher than the density of the molten salt, when the mixed solution is slowly cooled, the solid electrolyte powder coated with the molten salt may be precipitated in the lower portion of the mixed solution, as shown in FIG. 6. The solid electrolyte mixture (M2) coated with the molten salt may be solidified to separate an upper salt (S1) including only the molten salt (ES) and a lower salt (S2) including the molten salt (ES) and the solid electrolyte powder (EP) coated with the molten salt.

The position of the cutting line (CL) for separating the upper salt (S1) and the lower salt (S2) may be adjusted, depending on the amount of the molten salt intended to be contained in the composite solid electrolyte powder to be finally formed. An unnecessary molten salt (ES) may be removed by removing the upper salt (S1) on the cutting line (CL).

Therefore, the solid electrolyte particle having excellent crystallinity may grow at a low temperature using a molten salt, and also, the unnecessary molten salt may be removed, leaving only an appropriate amount of the molten salt without a complicated washing process.

A traditional solid electrolyte layer has an ion conductivity in a range of about 10⁻⁴ S/cm to about 10⁻³ S/cm at room temperature and an ion conductivity in a range of about 10⁻⁵ S/cm to about 10⁻² S/cm at a high temperature of 300° C. or higher.

The composite solid electrolyte layer 130 according to an example embodiment of the present disclosure has a low ion conductivity of about 10⁻⁴ S/cm at room temperature to decrease self-discharge of the thermal battery. In addition, the composite solid electrolyte layer 130 may greatly improve the output characteristics of the thermal battery, since the molten salt on the surface is melted at a high temperature of 300° C. or higher to have a high ion conductivity of about 10⁻² S/cm.

In addition, latent heat of fusion of the molten salt included in the composite solid electrolyte layer 130 decreases rapid thermal shock at the initial state of operation of the thermal battery to improve the thermal stability of the thermal battery.

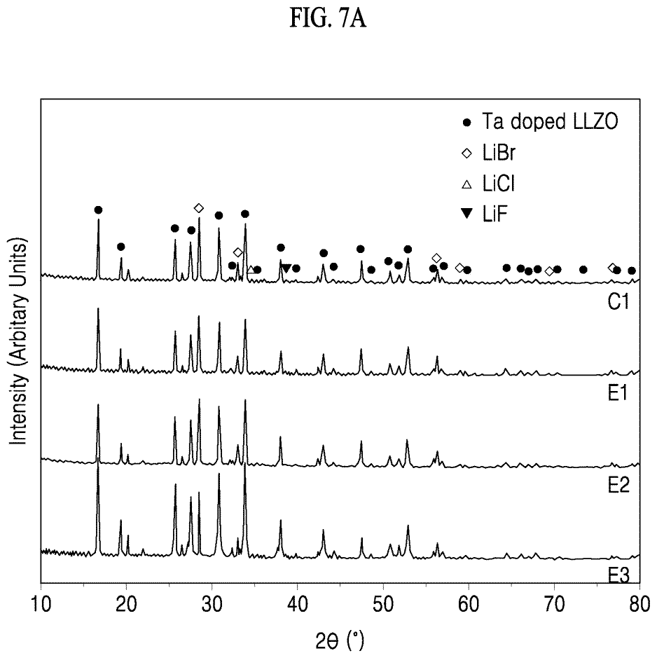

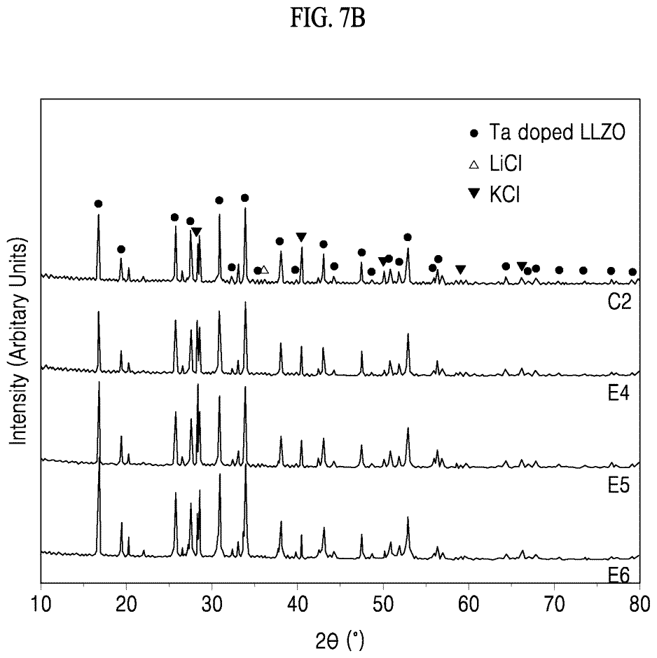

FIG. 7a is a graph showing the results of X-ray diffraction analysis of a composite solid electrolyte manufactured using a LiBr—LiCl—LiF molten salt, and FIG. 7b is a graph showing the results of X-ray diffraction analysis of the composite solid electrolyte manufactured using a LiCl—KCl molten salt.

Comparative Example 1 (C1) of FIG. 7a is a simple mixture of LiF—LiCl—LiBr molten salt powder and LLZO solid electrolyte powder. Example 1 (E1) is a composite solid electrolyte powder obtained by calcining a LiF—LiCl—LiBr molten salt powder and a precursor mixture at 1,000° C., Example 2 (E2) is a composite solid electrolyte powder obtained by calcining a LiF—LiCl—LiBr molten salt powder and a precursor mixture at 950° C., and Example 3 (E3) is a composite solid electrolyte powder obtained by calcining a LiF—LiCl—LiBr molten salt powder and a precursor mixture at 900° C. Herein, the precursor mixture was prepared by weighing lithium carbonate, lanthanum oxide, zirconium oxide, and an additive stoichiometrically. The additive included tantalum oxide and strontium carbonate. Each molten salt was melted and heat treated at 550° C. and then mixed with the precursor mixture.

Comparative Example 2 (C2) of FIG. 7b is a simple mixture of a LiCl—KCl molten salt powder and a LLZO solid electrolyte powder. Example 4 (E4) is a composite solid electrolyte powder obtained by calcining a LiCl—KCl molten salt powder and a precursor mixture at 1,000° C., Example 5 (E5) is a composite solid electrolyte powder obtained by calcining a LiCl—KCl molten salt powder and a precursor mixture at 950° C., and Example 6 (E7) is a composite solid electrolyte powder obtained by calcining a LiCl—KCl molten salt powder and a precursor mixture at 900° C.

Referring to FIGS. 7a and 7b, in the composite solid electrolytes manufactured according to the examples of the present disclosure, it was confirmed that the LLZO solid electrolyte crystals grew well, and there was no second phase production by the calcination temperature.

TABLE 1

| | LiCl—KCl | | LiF—LiCl—LiBr | |
|---|---|---|---|---|
| | Comparative | | Comparative | |
| Classification | Example 3 | Example 7 | Example 4 | Example 8 |
| Strength (gf) | 31 | 59 | 25 | 43 |

Table 1 shows the results of measuring the mechanical strength of the composite solid electrolyte layers manufactured according to the comparative examples and the examples. The composite solid electrolyte layer was formed in a disc shape having a diameter of 56.2 mm and a thickness of 0.43 mm, which was divided into 4 parts and measured for mechanical strength in a push pull gauge. In Comparative Example 3, the LiCl—KCl molten salt powder and the solid electrolyte powder were simply mixed and then pelletized to form the composite solid electrolyte layer, and in Example 7, the LiCl—KCl molten salt-precursor mixture was calcined to form the solid electrolyte mixture coated with the molten salt and then pulverized to obtain a composite solid electrolyte powder, which was pelletized to form a composite solid electrolyte layer. In Comparative Example 4, the LiF—LiCl—LiBr molten salt powder and the solid electrolyte powder were simply mixed and then pelletized to form a composite solid electrolyte layer, and in Example 8, the LiF—LiCl—LiBr molten salt-precursor mixture was calcined to form a solid electrolyte mixture coated with the molten salt and then pulverized to obtain a composite solid electrolyte powder, which was pelletized to form a composite solid electrolyte layer. Since in the composite solid electrolyte layer manufactured according to the examples of the present disclosure, the molten salts on the surface of the solid electrolyte were bonded to each other in the pelletization process, as described above, it was confirmed that the composite solid electrolyte layer manufactured according to the examples had higher strength than the composite solid electrolyte layer manufactured according to the comparative examples.

Although the present disclosure has been described with reference to the example embodiments shown in the accompanying drawings, they are only illustrative. It will be appreciated by those skilled in the art that various modifications and equivalent other example embodiments are possible therefrom. Accordingly, the true technical protection scope of the present disclosure should be determined by the technical spirit of the appended claims.

1. A method for manufacturing a composite solid electrolyte, the method comprising:
mixing a precursor mixture and a molten salt to form a molten salt-precursor mixture;
calcining the molten salt-precursor mixture to form a solid electrolyte mixture coated with the molten salt; and
pulverizing the solid electrolyte mixture coated with the molten salt to obtain a composite solid electrolyte powder.

2. The method for manufacturing a composite solid electrolyte of claim 1, wherein the molten salt is LiF—LiCl—LiBr, LiCl—KCl, LiF—LiBr—KBr, LiBr—KBr—RbCl, or a mixture thereof.

3. The method for manufacturing a composite solid electrolyte of claim 1, wherein the precursor mixture includes a raw material composition including a lithium element, a lanthanum element, and a zirconium element.

4. The method for manufacturing a composite solid electrolyte of claim 1, wherein the precursor mixture further includes an additive, and the additive includes one or more of tantalum oxide and strontium carbonate.

5. The method for manufacturing a composite solid electrolyte of claim 1, wherein the precursor mixture includes a raw material composition including a lithium element, a phosphorus element, and a sulfur element.

6. The method for manufacturing a composite solid electrolyte of claim 1, wherein a weight ratio of the molten salt to the molten salt-precursor mixture is 10 wt % to 80 wt %, and a weight ratio of the precursor mixture to the molten salt-precursor mixture is 20 wt % to 90 wt %.

7. The method for manufacturing a composite solid electrolyte of claim 6, wherein the weight ratio of the molten salt to the molten salt-precursor mixture is 30 wt % to 80 wt %, and the weight ratio of the precursor mixture to the molten salt-precursor mixture is 20 wt % to 70 wt %.

8. The method for manufacturing a composite solid electrolyte of claim 1, wherein a calcinating temperature of the molten salt-precursor mixture is 550° C. to 1,150° C.

9. The method for manufacturing a composite solid electrolyte of claim 1, wherein the forming of the solid electrolyte mixture coated with the molten salt includes:
calcining the molten salt-precursor mixture to form a mixed solution of a liquid phase molten salt and a solid phase electrolyte; and
solidifying the mixed solution to separate an upper salt including the molten salt and a lower salt including the solid electrolyte mixture coated with the molten salt.

10. A composite solid electrolyte manufactured by any one of claims 1 to 9.

11. A thermal battery comprising:
a negative electrode current collector;
a negative electrode layer placed on an upper portion of the negative electrode current collector;
a composite solid electrolyte layer placed on an upper portion of the negative electrode layer;
a positive electrode layer placed on an upper portion of the solid electrolyte layer; and
a heat source placed on an upper portion of the positive electrode layer, wherein the composite solid electrolyte layer is formed by mixing a precursor mixture and a molten salt to form a molten salt-precursor mixture, calcining the molten salt-precursor mixture to form a solid electrolyte mixture coated with the molten salt, pulverizing the solid electrolyte mixture coated with the molten salt to obtain a composite solid electrolyte powder, and pelletizing the powder.
